(19) United States
(12) Patent Application Publication
(10) Pub. No.: US 2004/0217292 A1
(43) Pub. Date: Nov. 4, 2004

(54) PET tomograph having continuously rotating panel detectors

(75) Inventors: J. Clifton Moyers, Oak Ridge, TN (US); Michael E. Casey, Knoxville, TN (US); Ronald Nutt, Knoxville, TN (US)

Correspondence Address: PITTS AND BRITTIAN P C, P O BOX 51295, KNOXVILLE, TN, 37950-1295, US

(73) Assignee: CTI PET Systems, Inc., Knoxville, TN

(21) Appl. No.: 10/836,755

(22) Filed: Apr. 30, 2004

Related U.S. Application Data
(60) Provisional application No. 60/466,812, filed on May 1, 2003.

(51) Int. Cl. G01T 1/164; G01T 1/166

(52) U.S. Cl. 250/363.03

(57) ABSTRACT

A Positron Emission Tomography (PET) tomograph having continuously rotating panel detectors. The PET tomograph includes two or more panel detector heads removably mounted on a rotating carriage system with a coincidence point source transmission system. Each panel detector head includes an array of scintillators, a light guide disposed behind the scintillators, and an array of detectors disposed behind the light guide. Each panel detector head further includes dedicated detector electronics for processing data collected from the detectors in that panel. Each detector block is comprised of an array of Lutetium Oxyorthosilicate (LSO) crystals. A rotational drive system is provided for continuously rotating the panel detector heads about the gantry frame. A data commutator is provided for communicating data from each detector panel head to a data processor. In order to remove heat generated by the panel detector heads, a chilled water cooling system is employed.

### CROSS-REFERENCE TO RELATED APPLICATIONS

This application claims the benefit of U.S. Provisional Application No. 60/466,812, filed May 1, 2003.

### STATEMENT REGARDING FEDERALLY SPONSORED RESEARCH OR DEVELOPMENT

Not Applicable

### BACKGROUND OF THE INVENTION

1. Field of Invention

The present invention pertains to the field of Positron Emission Tomography (PET). More particularly, the present invention is related to a PET tomograph having a plurality of continuously rotating panel detectors.

2. Description of the Related Art

Positron Emission Tomography (PET) has gained significant popularity in nuclear medicine because of the ability to non-invasively study physiological processes within the body. Applications employing the PET technology for its sensitivity and accuracy include those in the fields of oncology, cardiology and neurology.

Using compounds such as ¹¹C-labeled glucose, ¹⁸F-labeled glucose, ¹³N-labeled ammonia and ¹⁵O-labeled water, PET can be used to study such physiological phenomena as blood flow, tissue viability, and in vivo brain neuron activity. Positrons emitted by these neutron deficient compounds interact with free electrons in the body area of interest, resulting in the annihilation of the positron. This annihilation yields the simultaneous emission of a pair of photons (gamma rays) approximately 180° (angular) apart. A compound having the desired physiological effect is administered to the patient, and the radiation resulting from annihilation is detected by a PET tomograph. After acquiring these annihilation “event pairs” for a period of time, the isotope distribution in a cross section of the body can be reconstructed.

PET data acquisition occurs by detection of both photons emitted from the annihilation of the positron in a coincidence scheme. Due to the approximate 180° angle of departure from the annihilation site, the location of the two detectors registering the event define a chord passing through the location of the annihilation. By histogramming these lines of response (the chords), a sinogram is produced that may be used by a process of back-projection to produce a three dimensional image of the activity. Detection of these lines of activity is performed by a coincidence detection scheme. A valid event line is registered if both photons of an annihilation are detected within a coincidence window of time. Coincidence detection methods ensure (disregarding other second-order effects) that an event line is histogrammed only if both photons originate from the same positron annihilation.

Conventional PET tomographs include a plurality of detector rings, each ring encompassing a patient gantry. In various other configurations, stationary detector panels are provided. While various other imaging devices such as the MRI have provided rotating detectors, PET technology has prevented the use of rotating detectors.

### BRIEF SUMMARY OF THE INVENTION

The present invention is a Positron Emission Tomography (PET) tomograph having continuously rotating panel detectors. The PET tomograph includes a plurality of panel detector heads carried on a rotating carriage system with a coincidence point source transmission system. The panel detector heads define a conventional configuration, such as a conventional 35 cm×50 cm×2.0 cm LSO panel detector head. Conventional electronics are incorporated for use in conjunction with the functions of the detector heads.

The PET tomograph includes at least as many as six panel detector heads and as few as two panel detector heads mounted on the rotating carriage system. Each panel detector head includes an array of scintillators, a light guide disposed behind the scintillators, and an array of detectors disposed behind the light guide. Each panel detector head further includes dedicated detector electronics for processing data collected from the detectors in that panel. Each panel detector head is removably mounted on the rotating carriage system. By removably mounting each panel detector head, the system of the present invention is more easily maintained and installed.

A gantry housing serves as an enclosure for the panel detector heads and the gantry frame on which they are mounted. The gantry frame is configured to support a plurality of panel detector heads. The gantry frame supports six panel detector heads disposed in a hexagonal pattern, with each panel detector head being removable such that as few as two panel detector heads may be used. The sixth side may hold ⁶⁸Ge/⁶⁸Ga point sources in a design that allows simultaneous emission and transmission acquisitions with minimal effect on randoms, scatter and dead time.

A rotational drive system is provided for rotating the panel detector heads about the gantry frame. The rotating carriage is mounted to the gantry frame using a bearing assembly. The bearing assembly is disposed on one side of the rotating carriage, thereby carrying a cantilevered load. Alternatively, a support frame is disposed on either side of the patient tunnel, with each support frame carrying a bearing assembly. The rotational drive system includes an angular linear motor and belt drive power transmission.

A data commutator is provided for communicating data from the panel detector heads to a data processor. The data commutator is one of various devices such a slip ring or an optical commutator. The data commutator also provides power input to at least the electronics associated with each panel detector head.

In order to remove heat generated by the panel detector heads, a chilled water cooling system is employed. Alternatively, an integrated cabinet cooling system using refrigeration is employed with low noise and high reliability.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective illustration of a gantry housing adapted to receive the gantry frame, panel detector heads and associated circuitry constructed in accordance with various features of the present invention;

FIG. 2 is a front elevation view of the rotating gantry frame of the present invention, showing five panel detector heads being carried thereon in a hexagonal configuration;

FIG. 3 is an end view of a schematic illustration of a PET tomograph having continuously rotating panel detectors, wherein six panel detectors are provided to rotate about a patient gantry;

FIG. 4 illustrates a two-dimensional head sinogram derived from the embodiment of FIG. 3;

FIG. 5 illustrates a three-dimensional head sensitivity profile generated from rotating the embodiment of FIG. 3;

FIG. 6 is an end view of a schematic illustration of a PET tomograph having continuously rotating panel detectors, wherein five panel detectors are provided to rotate about a patient gantry;

FIG. 7 illustrates a two-dimensional head sinogram derived from the embodiment of FIG. 6;

FIG. 8 illustrates a three-dimensional head sensitivity profile generated from rotating the embodiment of FIG. 6;

FIG. 9 is an end view of a schematic illustration of a PET tomograph having continuously rotating panel detectors, wherein four panel detectors are provided to rotate about a patient gantry;

FIG. 10 illustrates a two-dimensional head sinogram derived from the embodiment of FIG. 9;

FIG. 11 illustrates a three-dimensional head sensitivity profile generated from rotating the embodiment of FIG. 9;

FIG. 12 is an end view of a schematic illustration of a PET tomograph having continuously rotating panel detectors, wherein three panel detectors are provided to rotate about a patient gantry;

FIG. 13 illustrates a two-dimensional head sinogram derived from the embodiment of FIG. 12;

FIG. 14 illustrates a three-dimensional head sensitivity profile generated from rotating the embodiment of FIG. 12;

FIG. 15 is an end view of a schematic illustration of a PET tomograph having continuously rotating panel detectors, wherein two panel detectors are provided to rotate about a patient gantry;

FIG. 16 illustrates a two-dimensional head sinogram derived from the embodiment of FIG. 15; and

FIG. 17 illustrates a three-dimensional head sensitivity profile generated from rotating the embodiment of FIG. 15.

### DETAILED DESCRIPTION OF THE INVENTION

A PET tomograph having continuously rotating panel detectors is disclosed. The PET tomograph is illustrated generally at 10 in the figures. The PET tomograph 10 includes a plurality of panel detector heads 32 carried on a rotating carriage system 20. In one embodiment, a coincidence point source transmission system is also carried by the rotating carriage system 20. The panel detector heads 32 define a conventional configuration, such as a conventional 35 cm×50 cm×2.0 cm LSO panel detector head. Conventional electronics 40 are incorporated for use in conjunction with the functions of the panel detector heads 32.

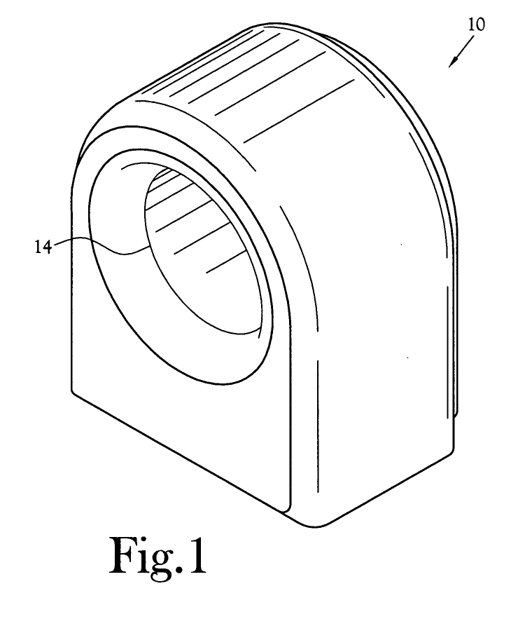

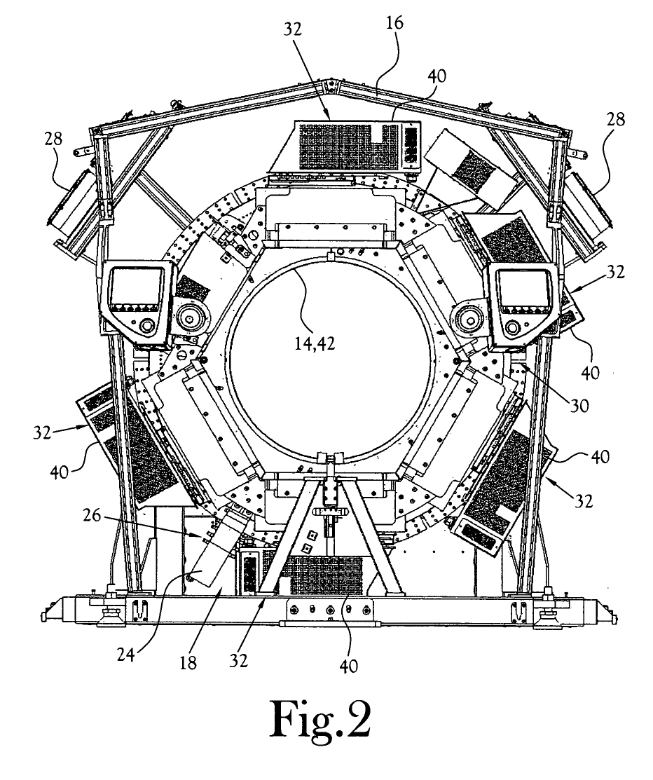

FIG. 1 illustrates the gantry housing 12 of the present invention. The gantry housing 12 serves as an enclosure for the panel detector heads 32 and the gantry frame 16 on which they are mounted. The gantry frame 16 is illustrated in FIG. 2.

The gantry frame 16 is configured to support a plurality of panel detector heads 32. In the illustrated embodiment the gantry frame 16 supports up to six panel detector heads 32 disposed in a hexagonal pattern. Each panel detector head 32 is removable such that as few as two panel detector heads 32 may be used. In one embodiment, one panel detector head 32 may be replaced with ⁶⁸Ge/⁶⁸Ga point sources in a design that allows simultaneous emission and transmission acquisitions with minimal effect on randoms, scatter and dead time. High sensitivity comes from the high stopping power of LSO and the large axial coverage. The intrinsic radiation from LSO does not unduly increase the randoms rate, but provides a convenient intrinsic calibration method.

A rotational drive system 18 is provided for rotating the panel detector heads 32 about the gantry frame 16. In one embodiment, a rotating carriage 20 is mounted to the gantry frame 16 using a bearing assembly 22. The bearing assembly 22 is disposed on one side of the rotating carriage 20, thereby carrying a cantilevered load. Alternatively, a support frame 16 is disposed on either side of the patient tunnel 14, with each support frame 16 carrying a bearing assembly 22. In the latter embodiment, follower bearings are used to support a purely vertical load. As such, less expensive bearings are required.

A data commutator 30 is provided for communicating data from the panel detector heads 32 to a data processor (not shown). To that extent, a single workstation controls the PET tomograph 10, acquires the data, performs image reconstruction and display. Fully three dimensional, as well as Fourier rebinned iterative reconstructions are available.

The data commutator 30 is one of various devices such a slip ring or an optical commutator. The data commutator 30 also provides power input to at least the electronics 40 associated with each panel detector head 32.

The rotational drive system 18 includes an angular linear motor 24 and a belt drive power transmission 26. This configuration results in a very high reliability low noise drive system.

The PET tomograph 10 of the present invention, when equipped with five panel detector heads 32, produces approximately 2000 watts of heat within the gantry housing 12. In order to remove the heat, a chilled water cooling system 28 is employed. Alternatively, an integrated cabinet cooling system using refrigeration is employed with low noise and high reliability.

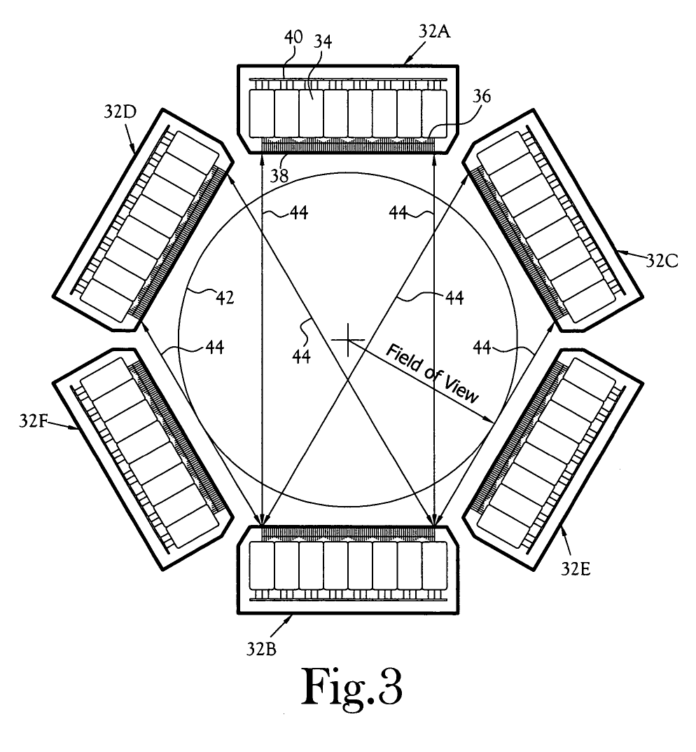

Illustrated in FIG. 3 is a PET tomograph having six detector panel heads 32A-F mounted on the rotating carriage system 20. The panels 32A-F are arranged in a hexagonal configuration about the field of view (FOV) 42 of the PET tomograph 10. Lines of response (LORs) 44 are defined between pairs of panel detector heads 32 as bounded by the LORs 44 illustrated by the double headed arrows. Illustrated in FIG. 3 are the LORs 44 between detector panel heads 32B and 32A; 32B and 32D; and 32B and 32C. The detector panel heads 32 are configured such that outermost LOR 44 with respect to the center of the FOV 42 of the PET tomograph 10 is tangent to the FOV 42. In order to cover the entire area of the FOV 42, the LORs 44 cover at least a region extending from the center of the FOV 42 to the circumference of the FOV 42. Even though the LORs 44 between either of the detector panel head pairs 32B:32D and 32B:32C cover such a region, the LORs 44 between the detector panel head paid 32B:32A covers the remaining region. As the detector panel heads 32 rotate about the FOV 42, it will be seen that the entire FOV 42 is covered by the three exemplary detector heads 32A, 32B, 32C. However, because there are six detector heads 32A-F present in the embodiment of FIG. 3, similar LORs 44 are defined by the remaining pairs of detector panel heads 32.

Each of the detector panel heads 32 in the illustrated embodiment includes a 8×11 array of photomultiplier tubes (PMTS) 34, a light guide 36 disposed on the PMT 34 array, and a 7×10 array of detector blocks 38 disposed on the light guide 36. The detector blocks 38 are positioned above the PMTs 34 in a quadrant-sharing arrangement. In the embodiment illustrated in FIG. 3, the detector panel head 32 is oriented such that the longer side is disposed in parallel with the longitudinal axis of the PET gantry 14. Accordingly, illustrated is the short side, on which is illustrated eight PMTs 34 and seven corresponding detector blocks 38. Although illustrated in this particular arrangement, it will be understood that other detector panel arrangements may be incorporated as well.

Each panel detector head 32 further includes dedicated detector electronics 40 for processing data collected from the detectors 38 in that panel 32. Each panel detector head 32 is removably mounted on the rotating carriage system 20. By removably mounting each panel detector head 32, the system of the present invention is more easily maintained and installed.

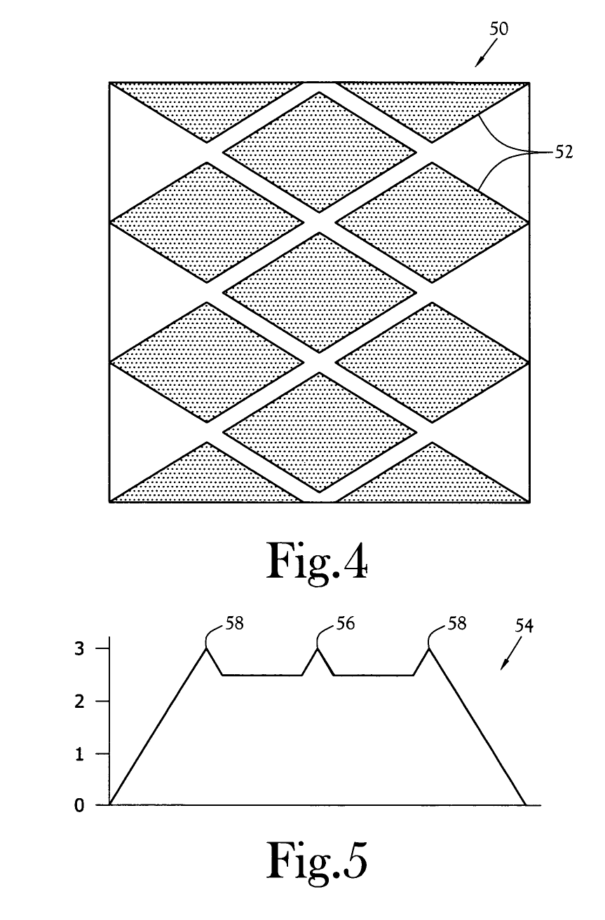

FIG. 4 illustrates graphically a two-dimensional sinogram 50 of the embodiment of FIG. 3, wherein six detector panel heads 32A-F are incorporated. Each diamond 52 illustrates a sinogram for a particular pair of detector panel heads 32. The center diamonds 52 represent the pairs of detector panel heads 32 which are directly opposite each other across the FOV 42. The diamonds 52 on the left and right sides of the sinogram 50 represent pairs of detector panel heads 32 which have a bounding LOR 44 tangential to the FOV 42.

FIG. 5 then illustrates a three-dimensional sensitivity profile 54 of the embodiment of FIG. 3. The profile 54 illustrates an integration of the two-dimensional sinogram 50 of FIG. 4 taking into account for the rotation of the detector panel heads 32A-F about the FOV 42.

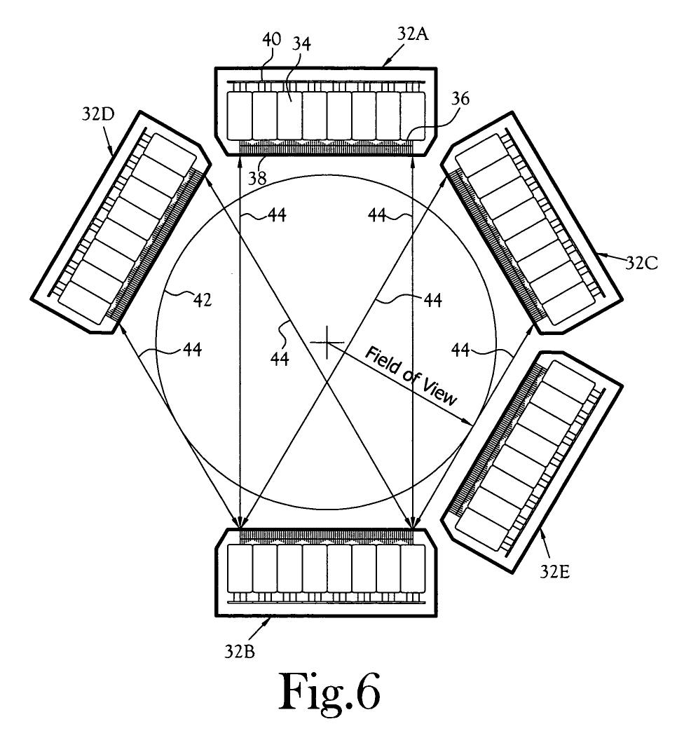

Illustrated in FIG. 6 is a PET tomograph 10 having five detector panel heads 32A-E mounted on the rotating carriage system 20. The panels 32A-E are arranged in the same configuration as in FIG. 3 described above. Similarly, the LORs 44 for the respective detector panel heads 32 demonstrate the same responses as in the previous embodiment. However, with one detector panel head 32F removed, the total number of corresponding pairs of detector panel heads 32 is reduced by three.

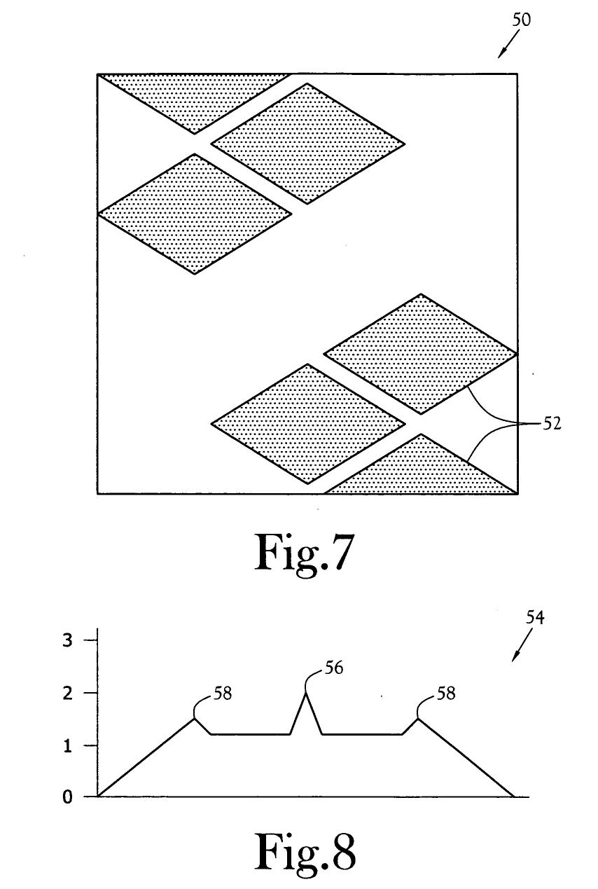

FIG. 7 illustrates graphically the two-dimensional sinogram 50 of the embodiment of FIG. 6. As compared to the corresponding two-dimensional sinogram 50 of FIG. 4, three fewer diamonds 52 are illustrated, those diamonds 52 representing the three fewer pairs of detector panel heads 32.

The loss of sensitivity due to the reduction in detector panel heads 32 is further illustrated in FIG. 8, which shows a sensitivity peak 56 corresponding to the center of the FOV 42 from 3 (see FIG. 5) to 2.

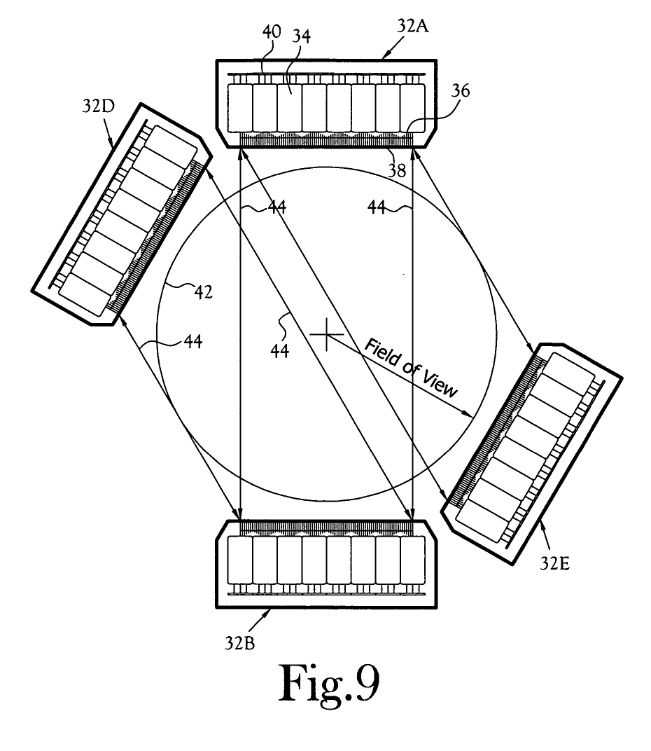

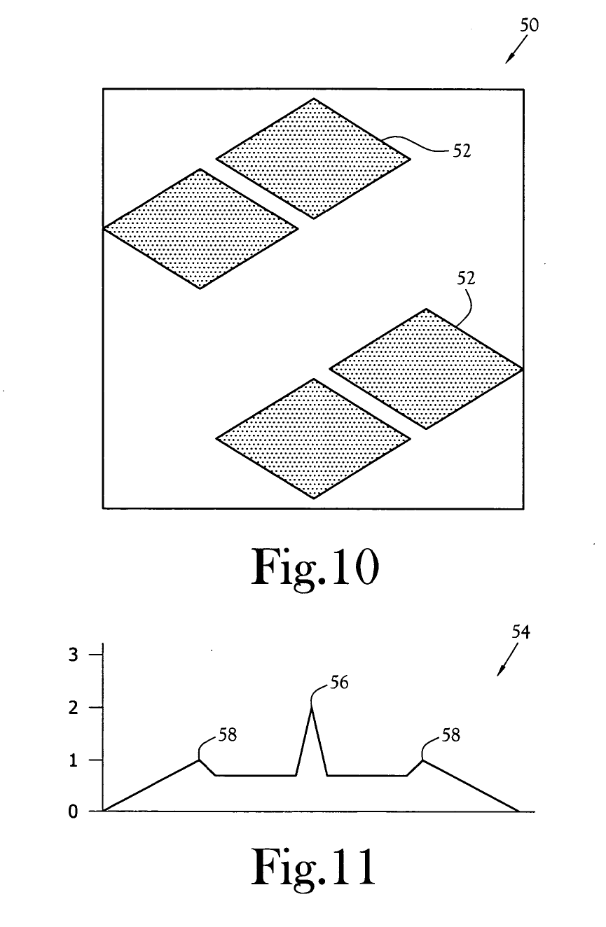

FIGS. 9-11 illustrate a PET tomograph 10 having four detector panel heads 32A, 32B, 32D, 32E. In this embodiment, the detector panel head 32C is removed, as compared to the embodiment of FIG. 6, thus effectively removing the LORs 44 between the detector panel head pair 32B:32C. FIG. 10 illustrates the reduction of diamonds 52 by one. While the sensitivity peak 56 remains at 2 at the center, the sensitivity peaks 58 at only 1 at points offset from the center of the FOV 42.

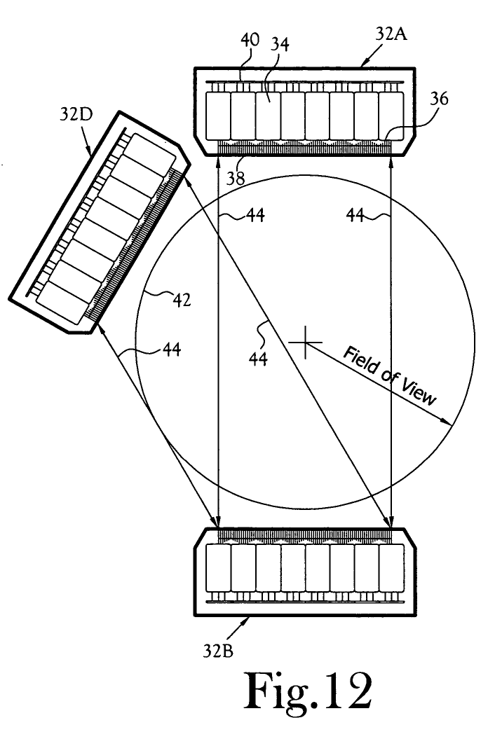

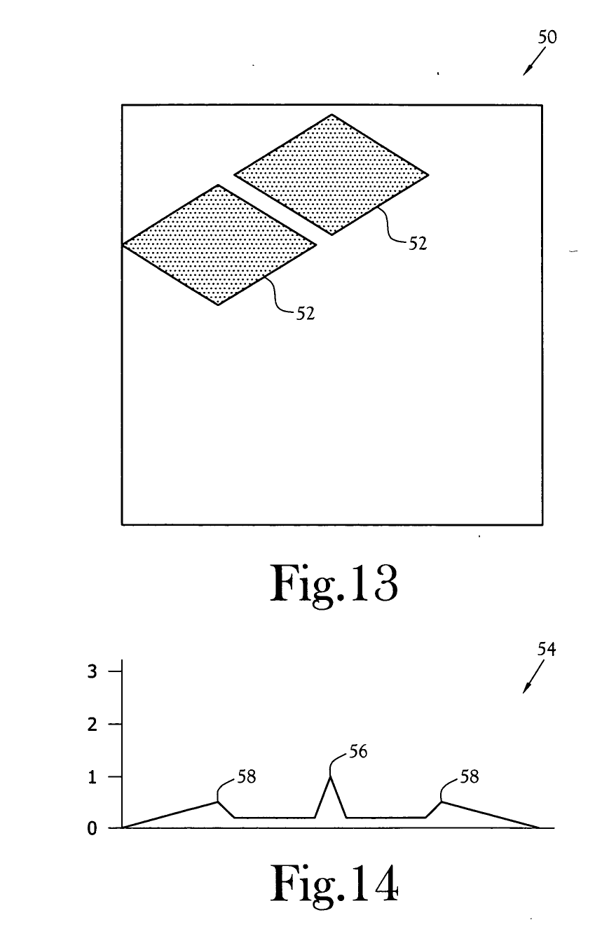

FIGS. 12-14 illustrate a PET tomograph 10 having three detector panel heads 32A, 32B, 32D. In this embodiment, the detector panel head 32E is removed, as compared to the embodiment of FIG. 9, thus effectively removing the LORs 44 between the detector panel head pair 32E:32D and 32E:32A. FIG. 13 illustrates the reduction of diamonds 52 by two. In this embodiment, the sensitivity peak 56 is reduced to 1 at the center, with sensitivity peaks 58 at 0.5 offset from the center of the FOV 42.

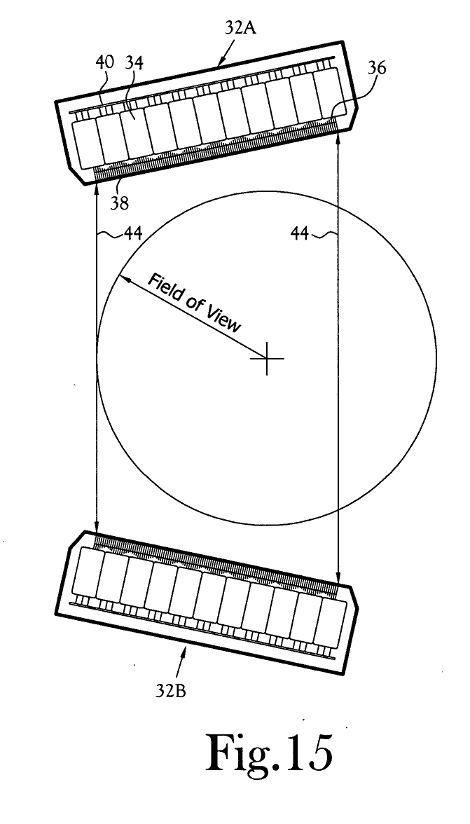

FIGS. 15-17 illustrate a special case in which only two detector panel heads 32A, 32B are incorporated. As described above, with the detector panel head 32 orientation of FIGS. 3-14, the LORs 44 between two offset detector panel heads 32 does not cover a region from the center of the FOV 42 to the periphery. Accordingly, the detector panel heads 32 of the previous embodiments are rotated 90° with respect to the longitudinal axis of the PET gantry 14 such that the short side is now oriented parallel with the longitudinal axis. A mounting bracket (not illustrated) adapted to mount the detector panel heads 32A, 32B to the rotating gantry 20 is provided. Further, the detector panel heads 32A, 32B are not disposed within the hexagonal geometry as before, but are disposed at an angle less that 30° but greater than zero. Specifically, the relative angle at with the two detector panel heads 32A, 32B are disposed is defined such that the shorter bounding LOR 44 is tangential with the FOV 42.

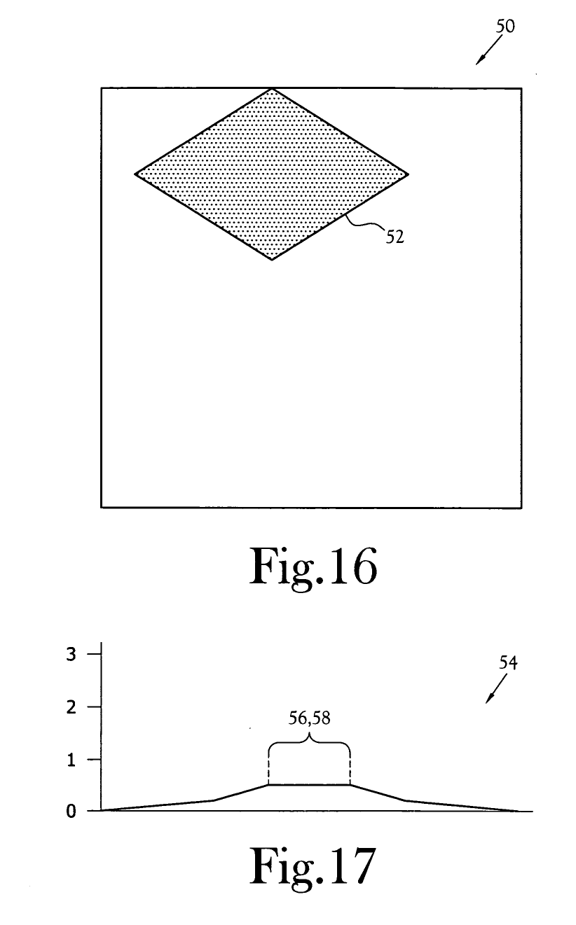

The resulting sinogram 50, as illustrated in FIG. 16, includes a single diamond 52, offset from center. As then illustrated in FIG. 17, the sensitivity peak 56,58 is effectively reduced to 0.5 over a region coincident with the center of the FOV 42.

Various factors determine the number of panel detector heads 32 incorporated in the PET tomograph 10 of the present invention. Among these are economic considerations and required throughput. With fewer panel detector heads 32, both the cost and the throughput are decreased. Conversely, as the number of panel detector heads 32 increases, the cost and the throughput both increase. Thus, if cost is the driving concern at installation of the PET tomograph 10, two panel detector heads 32 may be incorporated. For such a system, up to four more panel detector heads 32 may be installed at some point in the future in order to increase the throughput. Installation of a PET tomograph 10 of the present invention in such a fashion spreads the cost of the PET tomograph 10 over a period of time. Because the same rotating carriage 20 is adapted to carry from two to six panel detector heads 32, modification or replacement of the rotating carriage 20 is obviated.

It will be understood that, while the geometry presently disclosed is disclosed as including up to six panel detector heads 32, other geometries including more than six panel detector heads 32 is contemplated by the present invention. Specifically, it is contemplated by the present invention that the rotating carriage system 20 may be enlarged and/or the size of the panel detector heads 32 may be adapted such that six or more such panel detector heads 32 may be selectively mounted within the rotating carriage system 20.

From the foregoing description, it will be recognized by those skilled in the art that a PET tomograph having continuously rotating panel detectors has been provided. The PET tomograph includes a plurality of panel detector heads carried on a rotating carriage system with a coincidence point source transmission system. The panel detector heads are configured to be removable such that as few as two such panel detector heads are used. The PET tomograph of the present invention, when including fewer than the maximum number of panel detector heads, is upgradeable to include up to the maximum number. This new 3D tomograph, designed to take advantage of the properties of LSO and to perform simultaneous emission/transmission acquisitions routinely, provides increased performance over current images devices and reducing whole body acquisition times while maintaining optimal image quality. Other benefits, such as reduced patient motion, and minimized effects of non-steady state isotope distribution, also contribute significantly to improved image quality.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, arid illustrative examples shown and described. Accordingly, departures may be made from such details without departing from the spirit or scope of applicant's general inventive concept.

Having thus described the aforementioned invention, we claim:

1. A Positron Emission Tomography (PET) tomograph comprising:
a gantry frame;
a continuously rotating carriage carried by said gantry frame;
a plurality of panel detector heads removably mounted on said continuously rotating carriage to define a patient tunnel having a first end and a second end, said rotating carriage being adapted to limit movement of said plurality of panel detectors to circular motion about said patient tunnel, said plurality of panel detector heads being selectable and changeable after assembly of said PET tomograph and including at least two panel detector heads; and
a data commutator for communicating data from said plurality of panel detector heads.

2. The PET tomograph of claim 1 wherein said data commutator is a slip ring.

3. The PET tomograph of claim 1 wherein said data commutator is an optical commutator.

4. The PET tomograph of claim 1 further comprising a coincidence point source mounted on said continuously rotating carriage to cooperate with said plurality of panel detector heads.

5. The PET tomograph of claim 1 wherein each of said plurality of panel detector heads includes:
an array of scintillators;
a light guide disposed behind said array of scintillators;
a first array of detectors disposed behind said light guide; and
electronics for processing data collected from said first array of detectors.

6. The PET tomograph of claim 5 wherein said first array of detectors includes an array of detector blocks, each of said array of detector blocks including a second array of detectors.

7. The PET tomograph of claim 5 wherein each of said first array of detectors is fabricated from Lutetium Oxyorthosilicate (LSO).

8. The PET tomograph of claim 1 further comprising a rotational drive system for rotating said plurality of panel detector heads about said gantry frame.

9. The PET tomograph of claim 8 wherein said continuously rotating carriage is mounted to said gantry frame using a bearing assembly proximate one of said patient tunnel first and second ends.

10. The PET tomograph of claim 8 wherein said continuously rotating carriage is mounted to said gantry frame using a first bearing assembly proximate said patient tunnel first end and a second bearing assembly proximate said patient tunnel second end.

11. The PET tomograph of claim 8 wherein said rotational drive system includes an angular linear motor and a belt drive power transmission.

12. The PET tomograph of claim 1 further comprising a cooling system for discharging heat generated by said plurality of panel detector heads.

13. The PET tomograph of claim 1 further comprising a gantry housing adapted to enclose at least said gantry frame and said plurality of panel detector heads.

14. A Positron Emission Tomography (PET) tomograph comprising:
a gantry frame;
a continuously rotating carriage carried by said gantry frame;
a plurality of panel detector heads removably mounted on said continuously rotating carriage to define a patient tunnel having a first end and a second end, said continuously rotating carriage being adapted to limit movement of said plurality of panel detectors to circular motion about said patient tunnel, each of said plurality of panel detector heads including:
an array of scintillators;
a light guide disposed behind said array of scintillators;
an array of detector blocks disposed behind said light guide, each of said array of detector blocks including an array of detectors, each of said array of detectors being fabricated from Lutetium Oxyorthosilicate (LSO); and
electronics for processing data collected from said array of detectors;
said plurality of panel detector heads being selectable and changeable after assembly of said PET tomograph and including at least two panel detector heads;
a data commutator for communicating data from said plurality of panel detector heads; and
a gantry housing adapted to enclose at least said gantry frame and said plurality of panel detector heads.

15. The PET tomograph of claim 14 wherein said data commutator is a slip ring.

16. The PET tomograph of claim 14 wherein said data commutator is an optical commutator.

17. The PET tomograph of claim 14 further comprising a coincidence point source mounted on said continuously rotating carriage to cooperate with said plurality of panel detector heads.

18. The PET tomograph of claim 14 further comprising a rotational drive system for rotating said plurality of panel detector heads and said coincidence point source about said gantry frame.

19. The PET tomograph of claim 18 wherein said continuously rotating carriage is mounted to said gantry frame using a bearing assembly proximate one of said patient tunnel first and second ends.

20. The PET tomograph of claim 18 wherein said continuously rotating carriage is mounted to said gantry frame using a first bearing assembly proximate said patient tunnel first end and a second bearing assembly proximate said patient tunnel second end.

21. The PET tomograph of claim 18 wherein said rotational drive system includes an angular linear motor and a belt drive power transmission.

22. The PET tomograph of claim 14 further comprising a cooling system for discharging heat generated by said plurality of panel detector heads.
